(19) United States
(12) Patent Application Publication
(10) Pub. No.: US 2026/0290386 A1
(43) Pub. Date: Sep. 24, 2026

(54) MAGNETIC RECORDING AND REPRODUCTION DEVICE AND CONTROL METHOD OF THE SAME

(71) Applicants: Kabushiki Kaisha Toshiba, Tokyo (JP); Toshiba Electronic Devices & Storage Corporation, Tokyo (JP)

(72) Inventors: Kaori KIMURA, Yokohama Kanagawa (JP); Takao FURUHASHI, Kawasaki Kanagawa (JP); Masaya OHTAKE, Fujisawa Kanagawa (JP)

(21) Appl. No.: 19/239,939

(22) Filed: Jun. 16, 2025

(30) Foreign Application Priority Data
Mar. 21, 2025 (JP) 2025-046955

(51) Int. Cl. G11B 5/455; G11B 5/00; G11B 5/02

(52) U.S. Cl. CPC G11B 5/455; G11B 5/02; G11B 2005/0021

(57) ABSTRACT

According to one embodiment, a magnetic recording and reproduction device includes a heat-assisted magnetic recording head, a heat-assisted magnetic recording medium having a lubricant layer on the recording surface facing the head, a head characteristics monitor that monitors the characteristics of the head and detects that the change in the head characteristics over time slopes and indicates a step-like change from a first steady state to a second steady state, and a writability improvement unit that executes a writability improvement process in response to the detected information on the step-like change and reproduces a build-up.

### CROSS-REFERENCE TO RELATED APPLICATIONS

This application is based upon and claims the benefit of priority from Japanese Patent Application No. 2025-046955, filed Mar. 21, 2025, the entire contents of which are incorporated herein by reference.

### FIELD

Embodiments described herein relate generally to a magnetic recording and reproduction device and a control method of the same.

### BACKGROUND

In a heat-assisted magnetic recording head, the temperature of a magnetic disk is raised for recording by laser. It is known that, at this time, components considered to originate from a magnetic film of the magnetic disk adhere to a tip of a near-field transducer via the lubricant, and a hardened substance is generated. This hardened substance is called a build-up.

Here, it is known that some materials of the build-up can function as a layer for raising the laser transmission efficiency. When the flying height is lowered, the build-up is worn away and the head characteristics are deteriorated, whereas when the flying height is increased, the build-up is regenerated by the lubricant filling between the head and the medium, and the head characteristics can be improved.

In order to maintain the recording quality, it is important to control the build-up.

### BRIEF DESCRIPTION OF THE DRAWINGS

FIG. 1 is a block diagram illustrating a configuration example of a magnetic recording and reproduction device according to the first embodiment.

FIG. 2 is a partially exploded perspective view showing the magnetic recording and reproduction device according to the first embodiment.

FIG. 3 is a side view showing a magnetic head 10 and a suspension.

FIG. 4 is a transverse cross-sectional view showing some parts of the magnetic recording and reproduction device according to the first embodiment.

FIG. 5 is a flow diagram illustrating a method for controlling a magnetic recording and reproduction device according to the second embodiment.

FIG. 6 is a diagram of a graph illustrating an example of change in head characteristics with respect to recording time.

FIG. 7 is a model diagram showing a condition of a build-up due to step-like changes.

FIG. 8 is another model diagram showing a condition of a build-up due to step-like changes.

FIG. 9 is a model diagram showing a condition of a build-up due to step-like changes.

FIG. 10 is a flow diagram illustrating a method for control a magnetic recording and reproduction device according to Example 1.

FIG. 11 is a diagram of graph showing an example of step-like changes in BER.

FIG. 12 is a diagram of graph showing another example of step-like changes in BER.

FIG. 13 is a diagram of graph showing still another example of step-like changes in BER.

FIG. 14 is a diagram of graph showing still another example of step-like changes in BER.

FIG. 15 is a diagram of graph showing still another example of step-like changes in BER.

FIG. 16 is a diagram of graph showing still another example of step-like changes in BER.

FIG. 17 is a diagram of graph showing an example of a time interval for a head characteristics monitor.

FIG. 18 is a diagram of graph showing another example of a time interval for a head characteristics monitor.

### DETAILED DESCRIPTION

In general, according to one embodiment, a magnetic recording and reproduction device comprises a heat-assisted magnetic recording head including a main pole, a near-field transducer (NFT) which generates near-field light, a waveguide which transmits light to the near-field transducer, and a laser light source which supplies light to the waveguide, a heat-assisted magnetic recording medium having a lubricant layer on a recording surface opposing the heat-assisted magnetic recording head, a head characteristics monitor which monitors head characteristics of the heat-assisted magnetic recording head, and a writability improvement unit which executes a writability improvement process in response to information detected by the head characteristics monitor.

The head characteristics monitor monitors head characteristics of the heat-assisted magnetic recording head and detects that a change in the head characteristics over time indicates a step-like change. Here, the step-like change refers to a change from a first steady state to a second steady state via a slope.

Further, according to another embodiment, a method of controlling a magnetic recording and reproducing device is a control method which uses the above-provided magnetic recording and reproducing device, which comprises monitoring a change in head characteristics of the heat-assisted magnetic recording head, and detecting that the change in the head characteristics over time indicates a step-like change that slopes from a first steady state to a second steady state, by a head characteristics monitor, and regenerating a build-up by a writability improvement process.

According to the embodiments, the regeneration of a damaged build-up can be controlled, thereby making it possible to maintain the writability of the heat-assisted magnetic recording head at excellent level.

Embodiments will now be described with reference to the accompanying drawings.

The disclosure is merely an example and is not limited by contents described in the embodiments described below. Modification which is easily conceivable by a person of ordinary skill in the art comes within the scope of the disclosure as a matter of course. In order to make the description clearer, the sizes, shapes and the like of the respective parts may be changed and illustrated schematically in the drawings as compared with those in an accurate representation. Constituent elements corresponding to each other in a plurality of drawings are denoted by the same reference numerals and their detailed descriptions may be omitted unless necessary.

### EMBODIMENTS

The embodiments will now be described concretely by presenting examples.

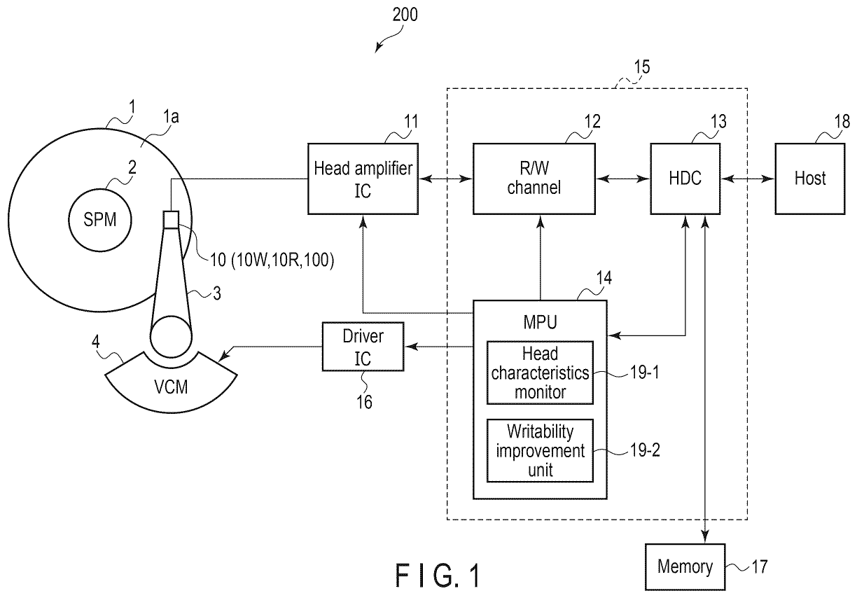

First, with reference to FIG. 1, a configuration example of a disk drive according to the first embodiment will be explained. Note that the configuration of the disk drive, which is a magnetic recording and reproduction device, shown in FIG. 1 is also applicable to each of the embodiments to be described later.

As shown in FIG. 1, a disk drive 200 is a magnetic recording and reproduction device of a perpendicular magnetic recording scheme, incorporating a magnetic disk 1 that is a perpendicular magnetic recording medium and a magnetic head 10 including a magnetic flux control layer to be described later.

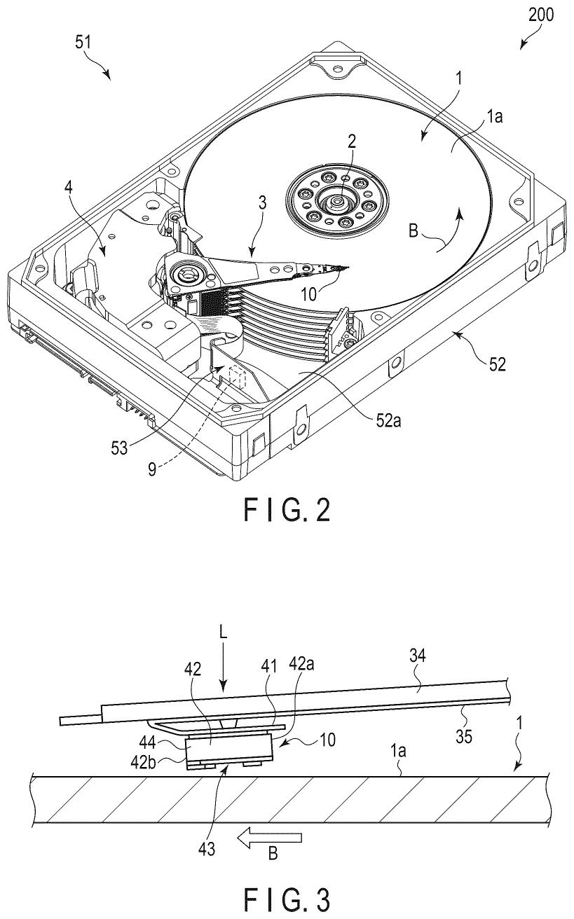

FIG. 2 is a partially exploded perspective view showing a magnetic recording and reproducing device according to the first embodiment.

FIG. 2 illustrates a state in which a plurality of magnetic disks 1 and a plurality of magnetic heads 10 are housed in a housing 51 in the magnetic recording and reproducing device according to the first embodiment, and a lid portion is omitted.

The magnetic disks 1 are fixed to a spindle motor (SPM) 2 and mounted to make rotational motion in a direction indicated by an arrow B. The magnetic heads 10 are mounted on an actuator 3 and are configured to move in a radial direction above recording surfaces 1a of the magnetic disks 1. The actuator 3 is driven to rotate by a voice coil motor (VCM) 4. The magnetic head 10 comprises a write head 10W, a read head 10R, and a thermal assist unit 100. The write head 10W writes data to the magnetic disk 1. The read head 10R reads data from the magnetic disk 1. The thermal assist unit 100 assists in writing data when the write head 10W writes data to the magnetic disk 1. The magnetic head 10 can include one or more magnetic heads.

Furthermore, the disk drive includes a head amplifier integrated circuit (hereinafter referred to as a head amplifier IC) 11, a read/write channel (R/W channel) 12, a hard disk controller (HDC) 13, a microprocessor (MPU) 14, a driver IC 16, and a memory 17. The R/W channel 12, the HDC 13, and the MPU 14 are incorporated into a controller 15, which consists of a single-chip integrated circuit.

The head amplifier IC 11 includes a circuit group for driving a laser diode for thermal assist, as will be described later. Further, the head amplifier IC 11 includes a driver that supplies to the recording head 10W a recording signal (write current) corresponding to the write data supplied from the R/W channel 12. In addition, the head amplifier IC 11 also includes a read amplifier that amplifies the read signal output from the reproducing head 10R and transmits the read signal to the R/W channel 12.

The R/W channel 12 is a signal processing circuit of the read/write data. The HDC 13 constitutes an interface between the disk drive and a host 18, and executes transfer control of the read/write data.

The MPU 14 is a main write operation controller of the disk drive and executes servo control necessary for controlling read/write operations and positioning the magnetic head 10. Furthermore, the MPU 14 includes a head characteristics monitor 19-1 that monitors changes in the head characteristics of the write head 10W at regular intervals, for example, and detects changes in the head characteristics over time that slope from the first steady state to the second steady state, and a writability improvement unit 19-2 that regenerates the build-up through a writability improvement process in response to the detection information of the head characteristics monitor 19-1.

The memory 17 includes a buffer memory composed of DRAM, a flash memory and the like. It can as well include a system area region of a magnetic recording medium.

FIG. 3 is a side view showing the magnetic head 10 and a suspension.

As shown in FIG. 3, each magnetic head 10 is constituted as a flying head, and includes a slider 42 having a shape of a substantially rectangular parallelepiped and a recording and reproducing head unit 44 provided at an outflow end (trailing end) of the slider 42. The magnetic head 10 is secured to a gimbal spring 41 provided at an end portion of a suspension 34. A head load L toward the recording surface 1a of the magnetic disk 1 is applied to each magnetic head 10 by the elasticity of the suspension 34. As shown in FIG. 2, each magnetic head 10 is connected to a head amplifier IC 11 and an HDC 13 via the suspension 34 and a wiring member (flexure) 35 fixed on the arm.

Next, the structure of the magnetic disk 1 and the magnetic head 10 will be described in detail.

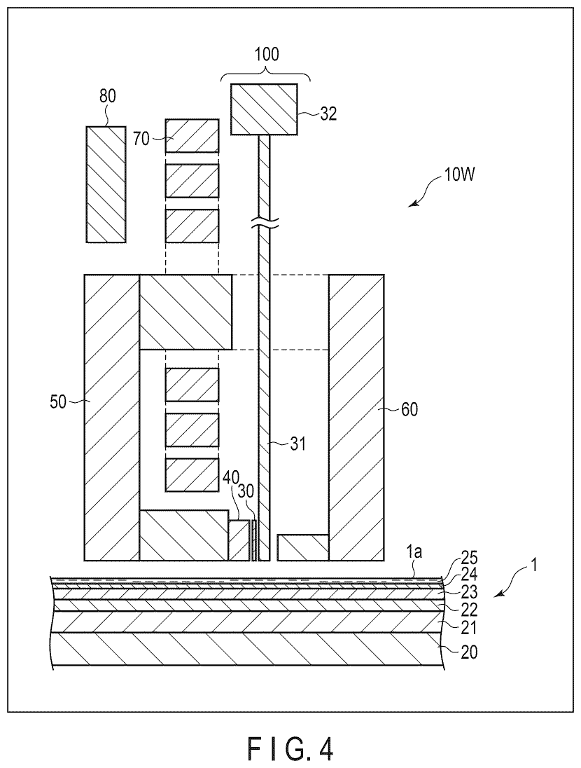

FIG. 4 is a transverse cross-sectional view showing the write head 10W and magnetic disk 1, which are parts of the magnetic recording and reproduction device.

The magnetic disk 1 includes a substrate 20, a heat sink layer 21, a crystal orientation layer 22, a perpendicular recording layer 23, and a protective layer 24 and a lubricant layer 25. The perpendicular recording layer 23 has a large anisotropy perpendicular to the disk surface. The crystal orientation layer 22 is arranged under the perpendicular recording layer 23 to improve the orientation of that perpendicular recording layer 23. The heat sink layer 21 is arranged under the crystal orientation layer 22 to suppress the spread of the heating area. The protective layer 24 is arranged on an upper part of the perpendicular recording layer 23 to protect the perpendicular recording layer 23. The lubricant layer 25 is a lubricant coating layer provided on the surface of the protective layer 24.

The magnetic head 10 is a separated magnetic head in which the recording head 10W and the reproducing head 10R are separated, and the recording head 10W is composed of a main magnetic pole 40 formed of a high permeability material that generates a magnetic field perpendicular to the recording surface 1a, a trailing yoke 50 magnetically bonded to the main magnetic pole that flows a magnetic flux to the main magnetic pole 40, a return shield magnetic pole 60 provided to efficiently close a magnetic path directly under the main magnetic pole, which is arranged on a leading side of the main magnetic pole 40, a coil 70 arranged to wrap around the magnetic path including the trailing yoke and the return shield magnetic pole to pass the magnetic flux to the main magnetic pole 40, a heater 80 for controlling the flying height of the recording head, a near-field transducer 30 that generates near-field light to heat the perpendicular recording layer 23 of the magnetic recording media 1 on the leading side of the main magnetic pole 40, and a waveguide 31 that transmits the light for generating the near-field light. A light source is incorporated such that a laser diode 32 is mounted on a slider of the actuator assembly 3. The near-field transducer 30 can be formed of, for example, Au, Pd, Pt, Rh, or Ir, or an alloy consisting of a combination of some of these. An insulating layer between the main magnetic pole and the near-field transducer can be formed of, for example, an oxide of SiO₂, Al₂O₃, or the like.

Recording methods for heat-assisted magnetic recording that can be used in the magnetic recording and reproduction device 200 include so-called Conventional Magnetic Recording (CMR) for writing data in tracks at intervals in the radial direction and performing recording such that adjacent tracks do not overlap, so-called Shingled Magnetic Recording (SMR) including tracks stacked in order in the radial direction and recording over parts of the adjacent tracks, or so-called Interlaced Magnetic Recording (IMR) including a bottom track and a top track in which adjacent tracks are stacked alternately and, after recording on the bottom track, recording while stacking the bottom track on the interlaced top track, or a combination of these methods.

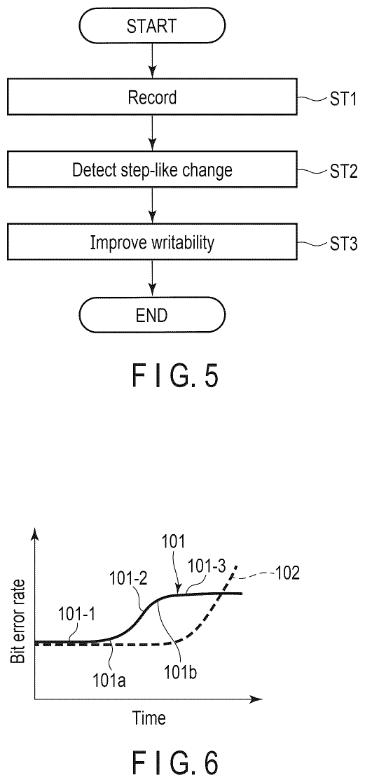

FIG. 5 is a flow diagram showing a control method for a magnetic recording and reproduction device according to the second embodiment.

The control method for the magnetic recording and reproduction device of the second embodiment can be carried out by using the magnetic recording and reproduction device of the first embodiment as shown in FIGS. 1 to 4.

First, a write operation is performed using a heat-assisted magnetic recording head 10 having an NFT 30 and a main pole 40 at its tip (ST1). With this operation, the lubricant filled from the lubricant layer 25 to the tip of the NFT 30 cures, and a build-up 26 can adhere to the gap between the heat-assisted magnetic recording head 10 and the magnetic disk 1.

During the write operation, the head characteristics monitor 19-1 monitors the change in the head characteristics of the heat-assisted magnetic recording head, and detects that the change in the head characteristics is a step-like change that changes from the first steady state to the second steady state (ST2). Upon receiving the detection information of the step-like change, the writability improvement unit 19-2 executes the writability improvement process (ST3) and regenerates the build-up. With the regenerating of the build-up, the efficiency of light transmission is improved, and the laser current value (LDI) for oscillating the laser is lowered, thereby making it possible to improve the writability. After the writability has been improved, the write operation of ST1 is performed.

According to the first and second embodiments, by detecting a step-like change in the change in the head characteristics with respect to the recording time, the damage to the build-up can be detected by distinguishing it from the life of the build-up. By performing the writability improvement process on the damaged build-up, the regeneration of the build-up can be controlled, and thus it is possible to maintain the writability of the heat-assisted magnetic recording head in good condition.

The step-like change indicates that at least part of the build-up is damaged, and the writability improvement process can regenerate at least part of the build-up.

FIG. 6 is a diagram of graph showing an example of the change in the head characteristics with respect to the recording time.

Here, the bit error rate (BER) is measured as an example of head characteristics. The vertical axis of the graph indicates the BER, which is expressed in common logarithms. The horizontal axis indicates time.

The step-like change can maintain its state around the first steady state, then slope up with the first inflection point, and then continue around the second steady state with the second inflection point, which is different from the first inflection point. Note that the number of inflection points is not limited to two, but there can be more than two.

A line 101 represents an example of such a step-like change.

As indicated by the line 101, a step-like change can progress from a first steady state 101-1 to a second steady state 101-3 via a slope 101-2. There are a first inflection point 101a between the first steady state 101-1 and the slope 101-2, and a second inflection point 101b between the slope 101-2 and the second steady state 101-3. As shown in the figure, the slopes of the first steady state 101-1 and the second steady state 101-3 are similar to each other, and the slope 101-2 between the first steady state 101-1 and the second steady state 101-3 is steeper than those of the first steady state 101-1 and the second steady state 101-3. This step-like change indicates that the build-up has been worn down or damaged, and therefore the BER has decreased.

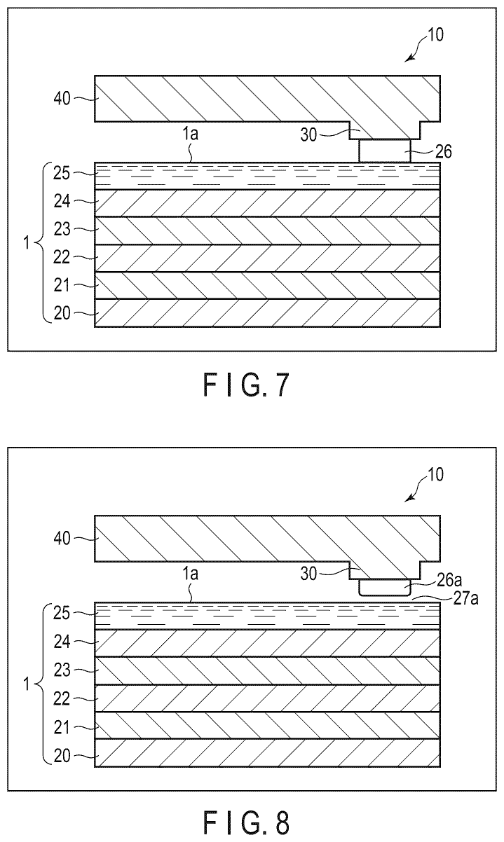

FIGS. 7 to 9 are model diagrams each illustrating the condition of the build-up in response to the step-like change.

As shown in FIG. 7, first, the heat-assisted magnetic recording head 10 having an NFT 30 and a main pole 40 at its tip is sought on a magnetic disk 1 having a magnetic recording layer 23, a protective layer 24, and a lubricant layer 25 coated on the protective layer 24, and a write operation is performed by the heat-assisted magnetic recording head 10. With this operation, the lubricant filled in from the lubricant layer 25 at the tip of the NFT 30 cures, and the build-up 26 can adhere to the heat-assisted magnetic recording head 10. When the build-up is formed, the efficiency of light transmission improves, and the optimal laser current value (LDI) during recording tends to decrease. FIG. 7 shows the build-up 26 in the first steady state 101-1 of FIG. 6, where there is no substantial gap between the magnetic disk 1 and the build-up 26, and no damage to the build-up has occurred. Therefore, the BER is kept low and remains in the first steady state 101-1.

As shown in FIG. 8, when the write operation is continued, for example, due to factors such as contact with a protrusion on the surface of the magnetic disk 1 or a sudden change in the space between the magnetic disk 1 and the heat-assisted magnetic recording head 10, the build-up 26 is partially damaged to become a build-up 26a, and a gap 27a is created between the magnetic disk 1 and the build-up 26a. FIG. 8 shows the damaged build-up 26a at the slope 101-2 in FIG. 6, and that the creation of the gap 27 between the magnetic disk 1 and the build-up 26a causes the efficiency of light transmission to decrease, and the BER gradually increases to show the slope 101-2.

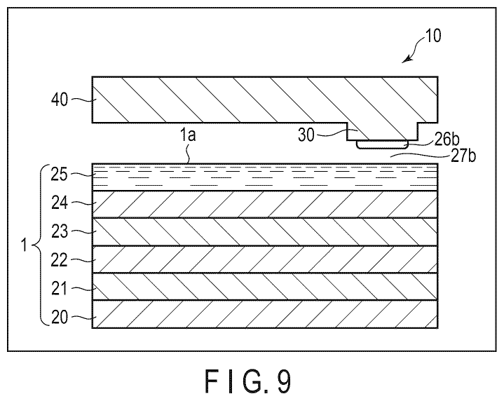

Further, as shown in FIG. 9, when the write operation is continued, most of the build-up 26 will be damaged and become like a build-up 26b, and a gap 27b, which is larger than the gap 27a, will be created between the magnetic disk 1 and the build-up 26b. FIG. 9 shows the damaged build-up 26b in the second steady state 101-3 of FIG. 6, and that the creation of a large gap 27b between the magnetic disk 1 and the build-up 26a causes the efficiency of light transmission to further decrease, and the BER to further increase, to be placed in the second steady state 101-3, showing a step-like change.

In the case of BER, the difference in the number of digits between the first steady state and the second steady state can be made 0.1 to 0.5 digits.

On the other hand, a line 102 in FIG. 6 indicates, for comparison, an example of the change in BER due to head life, which may be caused by changes in the shape of the NFT or oxidation of the main pole. As shown in the figure, in this case, the change in BER over recording time shows a rapid increase in behavior. Thus, the change in BER over time due to head life does not show a change in step-like change itself, and therefore such a change can be easily distinguished from the change in BER over time due to build-up damage.

When the head characteristics monitor 19-1 detects a step-like change, for example, at the time when it detects the second inflection point 101b of the step-like change, the writability improvement unit 19-2 can execute the writability improvement process. By the writability improvement process, the build-up can be regenerated and the BER can be improved.

As the writability improvement process, the write operation can be executed a plurality of times. The write operations can be executed in, for example, the data area or in a part of the area of the outer circumference within the media, adjacent to the data area. Or, the write operations can be performed in a non-data area, for example, the inter-band area of the SMR or the like. At this time, the write current can be set to on or off as required.

Multiple write operations can be performed in an area of the recording surface, where there are not bumps or the like, the write operation can be executed a plurality of times while the laser is in an on state. The height of head flying may be the same as the flying height during normal recording operations, but it can be made even higher. For example, it can be raised by 0 to 1 nm. Further, the heater power can be controlled so as to maintain the flying height at constant as much as possible.

When the write operation is performed while the laser is set to on, the lubricant warmed by the NFT 30 fills the gap 27b between the tip portion of the NFT 30 and the magnetic recording medium 1. As the write operation proceeds, a build-up is formed in the lubricant. When a build-up is formed, the efficiency of light transmission tends to improve, and the optimal LDI during recording tends to decrease, thereby making it possible to improve the BER.

The above-described gap 27b in the writability improvement process can be set according to the flying height of the head 10. In the writability improvement process, the write operation can be performed at a flying height higher than the flying height of the write operation during recording. Further, the writability improvement process can be performed while setting the flying height to a constant value.

The amount of build-up generated may be determined by the environment inside the magnetic recording and reproduction device and the ratio of a build-up material contained in the magnetic recording medium, comprising at least one of silicon (Si), aluminum, titanium or tantalum. Note here that silicon-based materials such as siloxanes may cause smearing (dirt) on the ABS (air bearing surface) of the head. Here, when there is a great amount of the build-up material, the build-up generated will be large, and when there is a small amount, it will be small.

As the head characteristics, in addition to the BER described above, for example, the squeeze bit error rate (SqBER), signal-to-noise ratio (SNR), squeeze SNR (SqSNR), and tracks per inch margin (TPIM) can be used.

The method for measuring the SqBER can be carried out as follows. First, a measurement pattern is written in the measurement track, and then a pattern that differs from the measurement pattern is written in both tracks adjacent thereto or in one side adjacent thereto once or more times. After that, reading is performed on the measurement track, and thus the BER can be obtained from the number of errors detected.

The method for measuring SqSNR can be carried out in a manner similar to that described above, except that the BER is replaced by the SNR. Further, in place of adjacent tracks, it is possible as well to write a few percent to a few tens of percent of the track width closer towards the measurement track than the adjacent tracks.

TPIM is an indicator of how much you can pack in TPI (track per inch) without erasing the adjacent track. First, you a pattern is written in the measurement track, and then a pattern is written on the adjacent track. Further, after returning to the measurement track for reading, the BER is measured. This flow is carried out while narrowing the TPI. Here, the value at the time when the BER of the measurement track becomes worse than the threshold value can be set as the TPIM.

In the magnetic recording and reproduction device of the embodiment, it is possible to appropriately detect and control the degradation of the build-up between the heat-assisted magnetic recording head and the magnetic recording medium. Therefore, a health monitor function can be added to the head characteristics monitor 19-1 of the heat-assisted magnetic recording head.

Here, the health monitor function refers to monitoring the change in head characteristics using the head characteristics monitor at regular intervals. With the characteristic values thus monitored, for example, when the BER is deteriorated due to the degradation of the recording head, the operating mode can be changed to “Write & Verify”, and after writing, the data can be read and checked. When there are any errors, the data can be rewritten. Alternatively, the operating mode can be changed to “Read only”, and in this mode, it can read but does not write.

Each interval time (constant time) can be calculated based on criteria such as the total write time or operating time. The operating time of a heat-assisted magnetic recording and reproduction device can be calculated based on the actual operating time while which the power of the heat-assisted magnetic recording and reproduction device is on. In this case, the running time is recorded in the workload. Further, the total write time can be calculated based on the total time obtained by adding up the write times and recording the total time for write. In this case, the heads have total write times different from each other, and therefore the total write time can be checked at regular intervals to monitor the head characteristics.

With the above-described operations, the changes in head characteristics due to head life and the changes in head characteristics due to build-up damage can be properly distinguished, and when damage to build-up is detected, the writability improvement process can be implemented using the writability improvement unit. By regenerating the build-up by the writability improvement process, it is possible to improve writability and maintain high write quality.

### Example 1

Example 1 illustrates an example case where the control method for the magnetic recording and reproducing device according to the second embodiment is performed using the magnetic recording and reproducing device of the first embodiment.

The head characteristics monitor in Example 1 has a function of checking the BER once per hour in terms of total write time. This total write time is calculated for each head. Although the value is calculated for each head here, the total value for all heads can be applied as well.

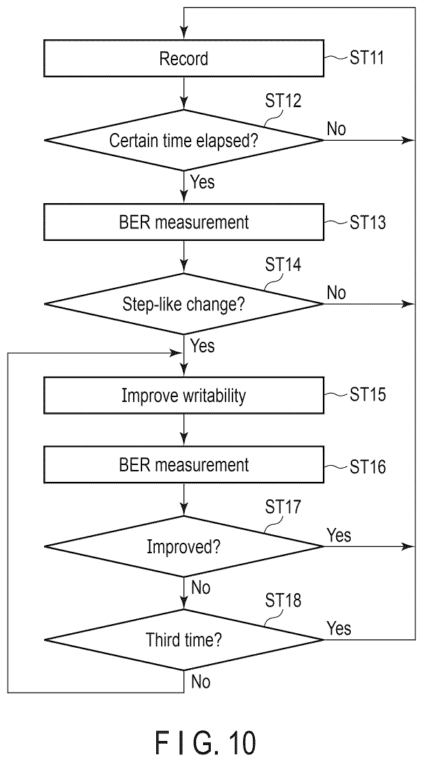

FIG. 10 is a flowchart illustrating the control method for the magnetic recording and reproduction device in Example 1.

First, write operation is performed using the heat-assisted magnetic recording head (ST11).

Next, the head characteristics monitor checks that one hour has elapsed since the start of the write operation (ST12), and when one hour has elapsed, the head is moved to the BER measurement track and to perform BER measurements of “write & read” and “read-only” (ST13). After the head characteristics monitor has confirmed that there is no abnormality in the read-only BER value and that the reader is working properly, when there is a fluctuation in the write-and-read BER value, it is compared with the data of BER of the past to detect step-like changes (ST14). If no step-like changes are detected, the process returns to the write operation in ST11. When a step-like change is detected, the writability improvement process is carried out by the head (ST15), and the BER is measured again (ST16). Then, it is judged whether the BER has been improved (ST17). When the BER has been improved, the process returns to the write operation in ST11 and normal operation is carried out. When the BER has not improved, the process returns to the writability improvement process in ST15 up to three times. Then, it is judged whether the BER is not improve after repeating the writability improvement process three times (ST18), and when it is improved, the process returns to the write operation in ST11 and normal operation is performed. When the BER is not improved, the BER is recorded, and the process returns to the write operation in ST11 and normal operation is performed. After that, the BER measurement is performed after one hour has elapsed in terms of total write time since the previous BER measurement, and this the process is repeated.

In the example, the regeneration of the build-up by the writability improvement process is carried out in the following procedure.

First, the head is set to values similar to those of the flying height and laser current for the head as in write operations of normal recording. Then, write operations are performed for a single track or multiple tracks for a few milliseconds to a few seconds. In order to create a build-up more stably, the write operations are performed by raising the flying height of the head by 0 to 2 nm above that of the usual cases. The write current may be or may not be applied, but because the laser current is on, when the site of the writing is in a data area, the pattern will be erased. When the writing is carried out in a data area, it is necessary to record the same pattern as the original one.

The build-up regeneration can be performed in the data area, in the dedicated area for build-up regeneration at the innermost or outermost circumference of the disk, or between the bands of SMR, or the like. The build-up regeneration may be performed in a single track, but when the write operation takes a long time, for example, several minutes, there is a concern that the head may be contaminated. Therefore, the build-up regeneration can be performed using multiple tracks. Further, during the regeneration process, the flying height can be set to a constant between the servo and data areas so as to reduce fluctuations in the flying height.

In Example 1, the writability improvement process was implemented by raising the flying height of the head by 0.5 nm in the innermost circumference of the non-data area and performing write operations under write conditions the same as those at the time when the data was recorded.

By detecting step-like changes and then performing the writability improvement process, the regeneration of damaged build-ups was controlled and the writability of the heat-assisted magnetic recording head could be maintained in good condition.

### Example 2

The head characteristics monitor was carried out for the indicators and thresholds for step detection listed in Table 1 below, other than the BER measurement.

As shown in Table 1, the indicators used for step detection were BER, sqBER, SNR, sqSNR, and TPIM. The thresholds for step detection were set to +0.3, +0.2, −3 dB, −3 dB, and 2 nm, respectively. The number of step detection points was 3, 3, 5, 5, and 5, in each respective case.

Note that the term “step detection” here includes the detection of points where the data for at least each indicator exceeds the threshold value. Therefore, the number of step detection points being 3 indicates that the slope is detected from the first steady state and the second steady state is detected from the slope by three or more data points.

Now, the build-up regeneration was performed using a writability improvement process similar to that of Example 1. According to this example, it was confirmed that the writability was improved without any problems in all conditions.

TABLE 1

| Step | | Step | Results of |
|---|---|---|---|
| detection | | detection | improvement in |
| indicators | Thresholds | points | writability |

| BER | +0.3 | | 3 | ◯ |
|---|---|---|---|---|
| sqBER | +0.2 | | 3 | ◯ |
| SNR | −3 | dB | 5 | ◯ |
| sqSNR | −3 | dB | 5 | ◯ |
| TPIM | 2 | nm | 5 | ◯ |

Note that in the table, symbol ◯ indicates that the improvement in writability was good.

### Example 3

Regarding the detection of a step by the BER, the threshold value for detecting changes in BER was varied from 0.1 to 0.8 as the step detection, and thus it was investigated whether the writability improvement could be achieved using a writability improvement process similar to that of Example 1. The test was conducted using twenty heads in each case. The results obtained are shown in Table 2 below.

As shown in Table 2, the threshold values for detecting changes in BER were set to five values: +0.1, +0.3, +0.5, +0.6, and +0.8. The number of step detection points was three in each case. The results of the writability improvement were 100% for +0.1, +0.3, and +0.5, but 80% for +0.6 and 10% for +0.8.

From these results, it was found in Example 3 that the optimal threshold value for detecting changes in BER was obtained in a range of 0.1 to 0.5. As such, the difference between the first steady state and the second steady state can be reduced from 0.1 to 0.5 digits. Note that it was found that, when the threshold value was raised excessively high, the heads are run for a long time without build-ups, and therefore more scratches were created on the surface, thereby making it not possible to expect a recovery in writability.

TABLE 2

| BER change | Step | Results of |
|---|---|---|
| detection | detection | improvement in |
| thresholds | points | writability |
| +0.1 | 3 | 100% |
| +0.3 | 3 | 100% |
| +0.5 | 3 | 100% |
| +0.6 | 3 | 80% |
| +0.8 | 3 | 10% |

### Example 4

In the embodiment, with the writability improvement process, the write operation can be carried out a plurality of times in a data area or a part of an inner or outer circumferential area of the data area of the heat-assisted magnetic recording medium, that is adjacent to the data area. In Example 3, as one example case, as the step detection indicators, BER, sqBER, and sqSNR were used as shown in Table 3 below. The step detections by BER were performed in the dedicated innermost and outermost circumferential areas of the magnetic recording medium, the step detection by sqBER was performed in the data area, and the detection by sqSNR was performed between the SMR bands. With respect to the results of the detections, the build-up regenerations were performed using a writability improvement process similar to that of Example 1. Then, it was confirmed that the writability was improved without any problems in all conditions. The results obtained are shown in Table 3 below.

TABLE 3

| | | Number of | Sites of | |
|---|---|---|---|---|
| Step | | step | writability | Improvement |
| detection | | detection | improvement | in |
| indicators | Thresholds | points | process | writability |
| BER | +0.3 | 3 | Dedicated innermost | ◯ |
| | | | circumferential area | |
| BER | +0.3 | 3 | Dedicated outermost | ◯ |
| | | | circumferential area | |
| sqBER | −3 dB | 3 | Data area | ◯ |
| sqSNR | −3 dB | 3 | Between SMR | ◯ |
| | | | bands | |

### Example 5

The step detection was performed by BER, and the setting of the flying height as shown in Table 4 below was tested for the writability improvement process. It was confirmed the improvement of the writability as in the case of Example 1 except for that of this example.

The threshold value for detecting a change in BER was set at +0.3, and the number of step detection points was set at 3 for each. The settings for the flying height in the writability improvement process were set to +0.2 nm and +0.5 nm, respectively. Further, between the servo and data, the step height was set at constant, and for another case between the servo and data, the flying height was set at step height and +0.2 nm.

As to the samples before and after the writability improvement process, the height of the build-up was checked using an atomic force microscope (AFM). In the states before the improvement, no substantial build-up could be observed, but after the improvement process, it was confirmed that an appropriate amount of build-up had adhered.

TABLE 4

| | | Number of | | |
|---|---|---|---|---|
| Step | | step | Writability | Improvement |
| detection | | detection | improvement | in |
| indicators | Thresholds | points | process | writability |
| BER | +0.3 | 3 | Raise flying | ◯ |
| | | | height by +0.2 nm | |
| BER | +0.3 | 3 | Raise flying | ◯ |
| | | | height by +0.5 nm | |
| BER | +0.3 | 3 | Constant flying | ◯ |
| | | | height between | |
| | | | servo/data | |
| BER | +0.3 | 3 | Constant flying | ◯ |
| | | | height between | |
| | | | servo/data + raise | |
| | | | flying height | |
| | | | by +0.2 nm | |

### Example 6

The changes in the characteristics of the head were monitored for fixed time intervals, and the criteria for the fixed time intervals were set as shown in Table 5 below. Then, it was confirmed that the writability was improved in all conditions.

The criteria and intervals for the fixed time were set to the following conditions: 3 hours and 1 hour for the total write time for the entire device, 1 hour and 30 minutes for the total write time for each head, and 24 hours and 2 hours for the operating time of the device, and monitoring of changes in the characteristics of the heads was carried out. With respect to the results detected by the monitoring, the build-up regenerations were performed using a writability improvement process similar to that of Example 1. Then, it was confirmed that the writability was improved without any problems in all conditions. The results obtained are shown in Table 5 below.

TABLE 5

| Criteria for | | Improvement |
|---|---|---|
| interval for | | in |
| constant time | Interval | writability |

| | | | |
|---|---|---|---|
| Total write | 3 | hours | ◯ |
| time for | | | |
| entire device | | | |
| Total write | 1 | hour | ◯ |
| time for | | | |
| entire device | | | |
| Total write | 1 | hour | ◯ |
| time for | | | |
| each head | | | |
| Total write | 30 | min. | ◯ |
| time for | | | |
| each head | | | |
| Operating time | 24 | hours | ◯ |
| of device | | | |
| Operating time | 2 | hours | ◯ |
| of device | | | |

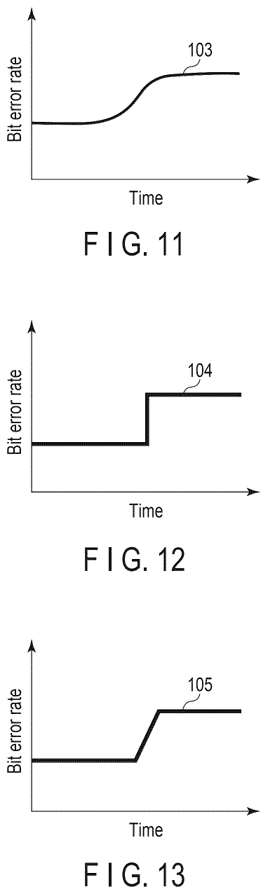

FIGS. 11 to 16 are diagrams by graph illustrating examples of step-like changes in the BER used in the embodiment.

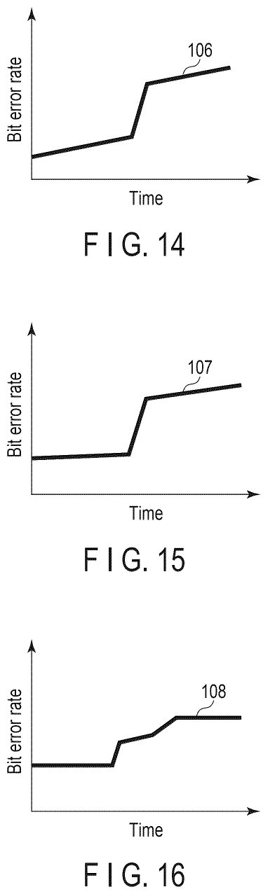

The step-like changes in BER measured in the embodiment include the followings: the one such as that indicated by a line 103 of FIG. 11, which changes while drawing a gentle curve; the one such as that indicated by a line 104 of FIG. 12, in which the first steady state and the second steady state cause a change of a clear rectangular shape; the one such as that indicated by a line 105 of FIG. 13, in which the first steady state, the slope, and the second steady state clearly change; the one such as that indicated by a line 106 of FIG. 14, in which the gradients of the first steady state and the second steady state are large; and the one such as that indicated by a line 107 of FIG. 15, in which the gradient of the second steady state is larger than that of the first steady state. Further, as indicated by a line 108 shown in FIG. 16, there may be in some cases two or more stages of steady states.

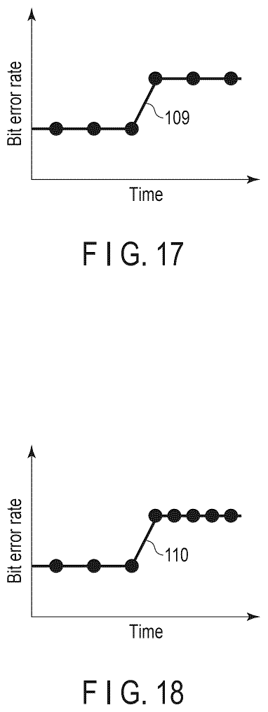

FIGS. 17 and 18 are diagrams by graph illustrating examples of the time intervals of the head characteristics monitors used in the embodiment.

The time intervals of the head characteristics monitor with BER and the like, used in the embodiment, can be carried out at regular time intervals, for example as indicated by a line 109 shown in FIG. 17. The time interval for carrying out the monitoring can be set based on the total write time, operating time or the like. Further, in case where the BER deteriorates to a threshold value or below or deteriorates by a certain amount of difference from the initial state, the time interval for monitoring can be shortened partially in accordance with necessity, as indicated by a line 110 shown in FIG. 18.

The detection of the step in the case indicated by the line 110 was carried out in the following manner, for example.

That is, during the normal write operation of the magnetic recording and reproduction device, the BER was maintained to a value close to the initial state, but at a certain point, the BER was deteriorated by 0.2 digits over a period of one hour and stabilized in that state. Here, the setting of the monitoring interval for the BER was changed from every hour to every 30 minutes based on the total write time per head. Further, the measurement for detecting the deterioration of the step was set to three points. For each measurement, the gradient of fluctuation of the BER was calculated. The gradient was obtained from the BER change/the interval between measurement points. When the gradient exceeded 0.03, a flag was raised for BER degradation, and when three or more stable states with a gradient of 0.03 or less were observed thereafter, the conditions for the occurrence of steps were met. Then, the process was moved to the writability improvement process.

While certain embodiments have been described, these embodiments have been presented by way of example only, and are not intended to limit the scope of the inventions. Indeed, the novel embodiments described herein may be embodied in a variety of other forms; furthermore, various omissions, substitutions and changes in the form of the embodiments described herein may be made without departing from the spirit of the inventions. The accompanying claims and their equivalents are intended to cover such forms or modifications as would fall within the scope and spirit of the inventions.

What is claimed is:

1. A magnetic recording and reproduction device comprising:
a heat-assisted magnetic recording head comprising a main pole, a near-field transducer which generates near-field light, a waveguide which transmits light to the near-field transducer, and a laser light source which supplies light to the waveguide;
a heat-assisted magnetic recording medium which comprises a lubricant layer on a recording surface facing the heat-assisted magnetic recording head;
a head characteristics monitor which monitors head characteristics of the heat-assisted magnetic recording head and detects that a change in the head characteristics over time indicates a step-like change from a first steady state via slope to a second steady state; and
a writability improvement unit which executes a writability improvement process in response to detected information on the step-like change and regenerates a build-up.

2. The device of claim 1, wherein
the step-like change transitions around the first steady state, slopes with a first inflection point, and then transitions around the second steady state with a second inflection point.

3. The device of claim 1, wherein
the head characteristics are any one of a bit error rate, squeeze bit error rate, signal-to-noise ratio, squeeze signal-to-noise ratio, or tracks per inch margin.

4. The device of claim 1, wherein
the head characteristics are the bit error rate, and a difference between the first steady state and the second steady state is 0.1 to 0.5 digits.

5. The device of claim 1, wherein
the writability improvement process includes performing the write operation a plurality of times in a data area or in a part of an inner or outer circumferential area of the heat-assisted magnetic recording medium, adjacent to the data area.

6. The device of claim 1, wherein
the writability improvement process includes performing a write operation at a flying height higher than the flying height of the write operation for recording.

7. The device of claim 1, wherein
the writability improvement process is performed with a flying height set at constant.

8. The device of claim 1, wherein
the step-like change indicates that at least a part of the build-up is damaged, and the writability improvement process includes regenerating at least a part of the build-up.

9. The device of claim 1, wherein
the head characteristics monitor monitors the change in the head characteristics each time a certain amount of time elapses based on a total write time accumulated.

10. The device of claim 1, wherein
the head characteristics monitor monitors the change in the head characteristics each time a certain amount of time elapses based on an operating time in which a power is on.

11. A method of controlling a magnetic recording and reproduction device comprising a heat-assisted magnetic recording head including a main pole, a near-field transducer which generates near-field light, a waveguide which transmits light to the near-field transducer, and a laser light source which supplies light to the waveguide, and a heat-assisted magnetic recording medium having a recording surface provided with a lubricant, the method comprising:
monitoring a change in head characteristics of the heat-assisted magnetic recording head, thereby detecting that the change in the head characteristics over time indicates a step-like change from a first steady state via slope to a second steady state; and
regenerating a build-up by a writability improvement process in response to detected information on the step-like change.

12. The control method of claim 11, wherein
the step-like change transitions around the first steady state, slopes with a first inflection point, and then transitions around the second steady state with a second inflection point.

13. The control method of claim 11, wherein
the head characteristics are any one of a bit error rate, squeeze bit error rate, signal-to-noise ratio, squeeze signal-to-noise ratio, or tracks per inch margin.

14. The control method of claim 11, wherein
the head characteristics are the bit error rate, and a difference between the first steady state and the second steady state is 0.1 to 0.5 digits.

15. The control method of claim 11, wherein
the writability improvement process includes performing the write operation a plurality of times in a data area or in a part of an inner or outer circumferential area of the heat-assisted magnetic recording medium, adjacent to the data area.

16. The control method of claim 11, wherein
the writability improvement process includes performing a write operation at a flying height higher than the flying height of the write operation for recording.

17. The control method of claim 11, wherein
the writability improvement process is performed with a flying height set at constant.

18. The control method of claim 11, wherein
the step-like change indicates that at least a part of the build-up is damaged, and the writability improvement process includes reproducing at least a part of the build-up.

19. The control method of claim 11, wherein
the head characteristics monitor monitors the change in the head characteristics each time a certain amount of time elapses based on a total write time accumulated.

20. The control method of claim 11, wherein
the head characteristics monitor monitors the change in the head characteristics each time a certain amount of time elapses based on an operating time in which a power is on.
